(19) United States
(12) Patent Application Publication
(10) Pub. No.: US 2025/0162825 A1
(43) Pub. Date: May 22, 2025

(54) HETEROGENEOUS PALLETISATION METHOD AND SYSTEM

(71) Applicants: FIVES SYLEPS, LORIENT (FR); UNIVERSITE GRENOBLE ALPES, SAINT MARTIN D’HÈRES (FR); INSTITUT POLYTECHNIQUE DE GRENOBLE, GRENOBLE (FR); CENTRE NATIONAL DE LA RECHERCHE SCIENTIFIQUE, PARIS (FR)

(72) Inventors: Alexandre LE JEAN, LORIENT (FR); Nadia BRAUNER, GRENOBLE (FR); Olivier BRIANT, GRENOBLE (FR)

(21) Appl. No.: 18/840,176

(22) PCT Filed: Feb. 23, 2023
(86) PCT No.: PCT/EP2023/054605

§ 371 Date: Aug. 21, 2024

(30) Foreign Application Priority Data
Feb. 24, 2022 (FR) 2201644

(51) Int. Cl. B65G 61/00

(52) U.S. Cl. CPC B65G 61/00; B65G 2201/0235; B65G 2203/0208

(57) ABSTRACT

A palletisation method, wherein: articles (i) are transported towards a loading point, the articles (i) are loaded by a loading device onto a container arranged in the loading station, the loading device being controlled by a computer control device, the method further including generating a stable arrangement of the articles (i) on the container upstream of their loading, the stable arrangement includes placing articles having substantially similar heights to form layers, wherein a partial layer having a first height occupies part of the container and at least one complementary partial layer having a second height occupies a second unoccupied part such that the entire surface area of the container is occupied.

### TECHNICAL FIELD OF THE INVENTION

The invention relates to the field of logistics platforms for large and medium-sized distributions and concerns a process and system for palletising articles prior to delivery to a customer.

### STATE OF THE ART

Logistics platforms act as intermediaries between suppliers and various points of sale. Suppliers send their products to these platforms, where they are received and processed for storage. The points of sale then send their replenishment requests to these platforms. For each request, the requested products are disbursed to be sent to an order preparation zone. In the preparation zone, robots are used to place products on shipping pallets, which will be then carried to their destination.

Besides managing disbursement of products and carrying orders to the customer, several decisions need to be made, including how many pallets to use, on which pallets to place articles and how to place articles on each pallet. When it comes to placing articles on a pallet, there are mainly two representations of layered solutions:
the first consists of a stack of interchangeable layers of the same width/length dimensions.
the second consists in placing layers of any dimensions without any precise rules to follow.

Because of the diversity of the articles to be placed, the first representation is too restrictive, as many articles cannot be placed in a complete layer, for example having the size 1200×800 mm, because of their small quantity. The near-optimal solutions obtained by the methods dedicated to this representation therefore place too few objects.

Furthermore, with the second representation, the diversity of possible layer dimensions makes the design of layered solutions too complex. Known methods fail to achieve good quality solutions, resulting in layouts with a low number of placed objects and a lack of stability.

The object of the invention is thus to provide a palletisation system and process for solving problems of the methods described above, and for achieving layered arrangements of articles on a container which are efficient in terms of articles placed as well as stability.

### SUMMARY OF THE INVENTION

To that end, according to a first aspect, the invention relates to a palletisation process wherein:
articles of heterogeneous shapes (especially having variable dimensions) are transported to a loading station by conveying means,
the articles are then loaded in several layers by a loading device onto a container arranged in the loading station,
   wherein, the loading device being controlled by a computer control means, the process further comprises a step of generating a stable arrangement of said articles on the container upstream of their loading.

According to the present invention, said stable arrangement comprises placing articles of substantially similar heights to form either complete layers occupying substantially the entire surface area of the container, or partial layers each occupying a part of the surface area of the container,

and wherein a first partial layer having a first layer height occupies a part of the container and at least one complementary partial layer having a second layer height occupies a second part not occupied by said first layer so as to occupy the entire surface area of the container.

Given the diversity of dimensions of the articles to be placed (especially their height), the process according to the invention defines layers of articles to be placed which can be complete (able to occupy the entire surface area of the container), or partial (able to occupy a part of the surface area). A layer is formed by articles having substantially similar heights (with a small gap between them).

By combining complete layers as well as partial layers in the solution, the process makes it possible to place a large number of articles on the container and therefore limit the volume possibly lost.

In addition, by placing the articles in layers and ensuring that they are properly positioned in terms of height, stability of the container is enhanced.

Consequently, unlike known methods, the process according to the invention enables efficient palletisation in terms of the number of articles placed and in terms of stability.

The container may be any container used for palletising articles for shipment, for example of articles to a customer. By way of example, this may be a pallet.

According to exemplary embodiments, a partial layer may occupy half the surface area of a container (for example half the length and the whole width or vice versa), it may also occupy other proportions such as 1/3 or 1/4.

By setting the number of possible layer sizes, the number of layers to be considered is thus limited, which can make it easier to obtain solutions quickly.

For example, add two stacks of quarter layers to the stacks of half layers. Depending on the dimensions of the objects to be placed, this alternative may prove much more effective. This alternative may be particularly useful if there are many small objects of very different heights.

Advantageously, two partial layers of substantially the same surface area can be superimposed. This makes it possible to fill a container, such as a pallet, by creating columns maximising volume occupied and stability.

Advantageously, two partial layers are separated by a partial spacer plate of substantially the same surface area as said partial layers. The use of spacers between partial layers of the same stack provides considerable added stability for the container after loading and therefore increases robustness of the arrangement.

Optionally, the nature of the spacer can make it possible to make up for height dispersions in the layer on which it is laid while remaining rigid, which further increases stability.

According to exemplary embodiments, a partial layer and at least one complementary partial layer are laid on a complete layer. By choosing this strategy, the volume occupied and stability are increased.

Advantageously, a complete spacer plate can also separate the complete layer from the partial layers, said complete spacer plate having substantially the same surface area as the container. This further increases stability.

According to embodiments, the process may comprise a step of generating a catalogue of layers likely to be placed on the container, said catalogue comprising at least one partial layer.

The advantage of a catalogue is that it defines possible layers upstream of any layer design and the process is restricted to using them in the most efficient way. The fact that the layer catalogue also includes partial layers makes it easy to obtain arrangements of articles on a container (for example a pallet) which maximise the volume occupied as well as stability.

According to embodiments, the catalogue can be progressively enriched by adding new possible layers having a strictly negative reduced cost, said reduced cost being deduced from the solution of the following linear problem, wherein the solution can be made by methods known to the person skilled in the art (for example the simplex method):

$$z ( C ) = max \text{?} {p}_{c} {λ}_{c}$$

$$with the provisos \text{?} {q}_{i}^{c} {λ}_{c} \leq {n}_{i} \text{?} i \text{?} I ( u )$$

$${λ}_{c} \geq 0 ∀ c \text{?} C$$

$$\text{?} \text{indicates text missing or illegible when filed}$$

where:
z(C): is a value corresponding to the highest layer profit that can be obtained using a real number of layers from the catalogue C.
p_{c}: is the profit of layer c, evaluated as the volume of objects in layer c plus a penalty proportional to the volume occupied by layer c in the container.
λ_{c}: the number of times layer c is used.
qᵢ^{c}: the number of articles i in layer c.
I: is a set of article references i known to the system.
ni: the number of times reference i can be used.

This dynamic generation method uses the above calculation formula for assigning a value of interest to each object in a given set of layers. This value, which can be positive or negative, is used to evaluate a layer that does not yet belong to the catalogue. If said layer has a strictly negative reduced cost, then it is added to the set of layers contained in the catalogue to improve the layered arrangement of articles obtained prior to palletising.

Another advantage is that if there are no more layers that satisfy the above condition, then the set of layers makes it possible to express an optimal solution. This property thereby allows us to know when to stop, but also to use other formulae to determine a limit on the quality of an optimal solution.

The reduced cost can be expressed by the formula:

$${p}_{c} - \text{?} {q}_{i}^{c} - α \text{?}$$

$$\text{?} \text{indicates text missing or illegible when filed}$$

Where uᵢ is the dual value of the only proviso in the problem.

The profit of a layer can be described by the following formula:

$${p}_{c} = {\sum }_{i ∈ I} {v}_{i} {q}_{i}^{c} - α {v}_{c}$$

Where v_{c} is the volume of the layer and α is a sufficiently small real number so that the profit of two layers is first evaluated according to the volume of the objects placed.

For this same volume, the profit is compared according to the volume occupied by the layer (this can also be referred to as the ‘density’ of the layer).

$${\sum }_{c ∈ C} {q}_{i}^{c} {λ}_{c} \leq {n}_{i}$$

By adding a variable εᵢ ϵ [symbol] and integrating it into the proviso, there is obtained:

$${\sum }_{c ∈ C} {q}_{i}^{c} {λ}_{c} = {n}_{i} - {ε}_{i}$$

It is also possible to reformulate the objective of maximising the volume as minimising the unplaced volume:

$$\begin{matrix}max {\sum }_{c ∈ C} {p}_{c} {λ}_{c} = max {\sum }_{c ∈ C} ( {\sum }_{i ∈ I} {v}_{i} {q}_{i}^{c} - α {v}_{c} ) {λ}_{c} \\ = max {\sum }_{i ∈ I} ( {v}_{i} {\sum }_{c ∈ C} ( {q}_{i}^{c} {λ}_{c} ) ) - α {\sum }_{c ∈ C} {v}_{c} {λ}_{c} \\ = max {\sum }_{i ∈ I} ( {v}_{i} ( {n}_{i} - {ε}_{i} ) ) - α {\sum }_{c ∈ C} {v}_{c} {λ}_{c} \\ = {\sum }_{i ∈ I} {v}_{i} {n}_{i} + max - {\sum }_{i ∈ I} {v}_{i} {ε}_{i} - α {\sum }_{c ∈ C} {v}_{c} {λ}_{c} \\ = {\sum }_{i ∈ I} {v}_{i} {n}_{i} + min {\sum }_{i ∈ I} {v}_{i} {ε}_{i} + α {\sum }_{c ∈ C} {v}_{c} {λ}_{c}\end{matrix}$$

According to exemplary embodiments, in order to generate a stable arrangement of articles, the layers which maximise the sum of profits are selected from the catalogue under the proviso that all the layers can be arranged on the container without exceeding a height limit of the container set upstream.

For a catalogue C of layers c, it can be, for example, determined which layers to choose in order to constitute the solution by solving the following linear program (the resolution methods being known to operations research specialists):

$$\begin{matrix}{z}_{IP} ( C ) = max & {\sum }_{c ∈ C} {p}_{c} {λ}_{c} & \\ with the provisos & {\sum }_{c ∈ C} {q}_{i}^{c} {λ}_{c} \leq {n}_{i} & ∀ i ∈ I \\ & h ( λ ) & \\ & {λ}_{c} ∈ ℕ & ∀ c ∈ C\end{matrix}$$

The proviso h(A) ensures that it is possible to place the set of layers without any of them exceeding the height limit set, noted H.

Optionally, the process can include the use of a learning method to generate the layers given as parameters to the “linear programming in integers”. This provides improvement when the objects to be palletised change little from one resolution to another.

Optionally, the computer means can include an internal memory, thus saving the recurring layers passed as parameters to the “linear programming in integers”.

Optionally, the process can comprise applying the method to a set of objects to be placed on more than one pallet. The distribution of the objects should thereby be taken into account, their integration being facilitated by the notion of layers.

The invention according to a second aspect also concerns a palletisation system implementing the process according to one of the combinations of characteristics described above.

The palletisation system may comprise:
a loading station which may comprise a zone for receiving a container and a loading device,
conveying means for transporting articles of heterogeneous shapes to the loading station to be loaded in several layers onto the container by the loading device,
   wherein the loading device is controlled by computer control means configured to generate a stable arrangement of said articles on the container by implementing the process as described above.

### BRIEF DESCRIPTION OF THE FIGURES

Further features and advantages of the invention will become apparent from the description below in connection with the appended drawings, given as non-limiting examples of the invention, wherein:

FIG. 1 represents an example of a palletisation system according to the invention;

FIG. 2 is an illustration of a loaded pallet comprising complete layers of articles and half-layers.

### DETAILED DESCRIPTION

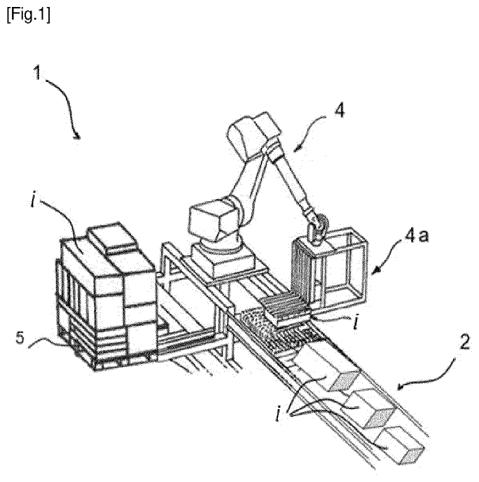

FIG. 1 represents an example of a palletisation system according to the invention. The system 1 comprises a conveying means 2 for transporting articles i to a loading station to load onto an empty container 5 (pallet) arranged in the loading station. In the example, the conveying means 2 is a conveyor, but other conveying means can be used, especially automatically guided robots (AMR/AGV).

Palletisation system 1 also includes a loading means 4 for loading articles i onto pallet 5. The loading means 4 is, for example, a multi-axis robot equipped with a gripper 4a for gripping the articles i one by one and placing them on the pallet 5. The gripper 4a may have a grid as shown in the figure or other known shapes, for example provided with suction cups.

In one alternative not shown, the palletisation system 1 can also comprise an article detection means, for example a camera, arranged above the conveying means 2 in the vicinity of the loading station.

The system 1 also comprises a control means, not shown, arranged to manage loading of articles by the loading means 4. It may also control the conveying means.

The control means may comprise calculation means, such as software, which can determine an order of arrangement and spatial positions for the articles i to be stacked on the pallet 5.

Advantageously, the control means may also comprise a memory configured to host a database containing the characteristics of the parcels to be stacked, for example as a result of a customer's order. The database may include dimensions, weights or other characteristics of the articles.

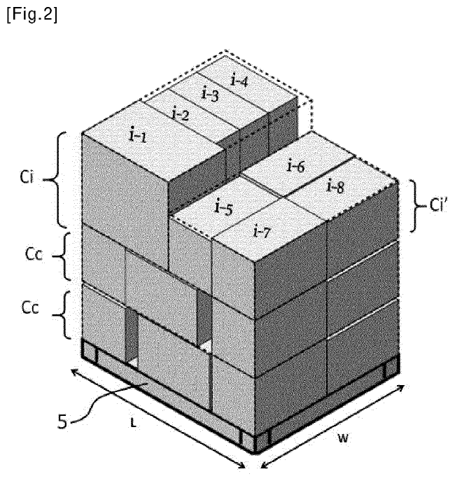

FIG. 2 shows an example of an arrangement of articles on a pallet 5 being loaded using the process according to the invention. In the article arrangement illustrated, the process has placed two complete layers Cc superimposed on each other, each comprising a set of articles of similar height. Next, articles i-1 to i-4 with similar heights are arranged in a partial layer Ci occupying half the surface area of pallet 5. Articles i-5 to i-8 with similar heights are arranged in a complementary partial layer Ci′ occupying the other half of the surface area of the pallet.

Other partial layers can be added to the layers Ci and Ci′, for example one or several layers of the same dimensions can be superimposed on Ci′. These two layers can also be separated by an spacer plate to enhance stability of the pallet. Spacer plates can also be added between the complete layers and between the upper complete layer Cc and the partial layers Ci, Ci′ to increase stability.

### Dynamic Generation of a Layer Catalogue

To generate the catalogue, and progressively enrich it by considering articles not yet included, software included in the computer control means calculates a reduced cost for each possible complete layer Cc or partial layers Ci, which may correspond to:

$${p}_{c} - {\sum }_{c ∈ C} {u}_{i} {q}_{i}^{c}$$

If the value of the reduced cost is strictly negative, then the layer is added to the catalogue.

The operation is repeated until no new partial or full layer satisfies the above condition.

In the expression above, uᵢ is the dual value of the layer c considered (the only proviso in the problem).

The values of uᵢ and the reduced cost are derived by solving the following linear problem:

$$\begin{matrix}z ( C ) = max & {\sum }_{c ∈ C} {p}_{c} {λ}_{c} & \\ with the provisos & {\sum }_{c ∈ C} {q}_{i}^{c} {λ}_{c} \leq {n}_{i} & ∀ i ∈ I ( u ) \\ & {λ}_{c} \geq 0 & ∀ c ∈ C\end{matrix}$$

where:
z(C): is a value corresponding to the highest layer profit that can be obtained by using a real number of layers from the catalogue C.
λ_{c}: the number of times layer c is used.
qᵢ^{c}: the number of articles i in layer c.
I: is a set of article references i known to the system.
ni: number of times reference i can be used.
p_{c}: is the profit of layer c, evaluated as the volume of articles in layer c plus a penalty proportional to the volume occupied by layer c in the container. It can be expressed by the following formula:

$${p}_{c} = {\sum }_{i ∈ I} {v}_{i} {q}_{i}^{c} - α {v}_{c}$$

where v_{c} is the volume of the layer and α a sufficiently small real number so that the profit of two layers is first evaluated according to the volume of the objects placed. For this same volume, the profit is compared on the volume that the layer occupies.

Methods for solving such a problem are familiar to operations research specialists and are therefore not detailed here. Well-known solvers, such as GLPK, can be used to solve the problem.

Selection of layers to be placed:

In this step, the process is implemented by the software to select complete or partial layers from the catalogue to be placed on the container (pallet) by robot 4. The layers chosen from the catalogue C are those which maximise the sum of the profits (p_{c}) under the proviso that all the layers chosen can be placed on the container and without exceeding a height limit of the container, set upstream.

The layers are selected by solving the following linear programming (the solving methods are known to operations research specialists):

$$\begin{matrix}{z}_{IP} ( C ) = max & {\sum }_{c ∈ C} {p}_{c} {λ}_{c} & \\ with the provisos & {\sum }_{c ∈ C} {q}_{i}^{c} {λ}_{c} \leq {n}_{i} & ∀ i ∈ I \\ & h ( λ ) & \\ & {λ}_{c} ∈ ℕ & ∀ c ∈ C\end{matrix}$$

The proviso h(A) ensures that it is possible to place the set of layers without any of them exceeding the height limit set, noted H.

For example, for complete layers, the proviso h(A) can be expressed as follows:

$${\sum }_{c ∈ C} {h}_{c} {λ}_{c} \leq H$$

Where h_{c} is the height of layer c.

If full layers and half-layers having dimensions 600×800 or half-layers 1200×400 are used, the provisos to be added are:

$$\begin{matrix}{λ}_{c} = {λ}_{c}^{D} + {λ}_{c}^{G} & ∀ c ∈ {C}_{1 / 2} \\ {\sum }_{c ∈ {C}_{1}} {h}_{c} {λ}_{c} + {\sum }_{c ∈ {C}_{1 / 2}} {λ}_{c}^{D} \leq H & \\ {\sum }_{c ∈ {C}_{1}} {h}_{c} {λ}_{c} + {\sum }_{c ∈ {C}_{1 / 2}} {λ}_{c}^{G} \leq H & \\ {λ}_{c}^{D} ∈ ℕ & ∀ c ∈ C \\ {λ}_{c}^{G} ∈ ℕ & ∀ c ∈ C\end{matrix}$$

Where C₁⊆C is the set of full layers in the catalogue, and C_{1/2}⊆C the half-layers in the catalogue.

The variables λ_{C}^{D} and λ_{C}^{C} respectively indicate the number of half-layers on the right and left that will be stacked on the pile of full layers.

### Comparison of the Dynamic Method with a Random Method

To evaluate effectiveness of the dynamic generation method described above, it is compared with a random generation method known from prior art.

Results obtained for Z(C) in both cases, as well as the results obtained for a Lagrangian bound (known to the skilled person) used as a reference, are represented below.

Simple instances: Z(C) (Dynamic): 172; θ(u): 170; Z(C) (Random): 179

Medium instances: Z(C) (Dynamic): 171; θ(u): 155; Z(c) (Random): 230

Difficult instances: Z(C) (Dynamic): 145; θ(u): 128; Z(C) (Random): 190

To illustrate the difference between both methods, the GAP (in percentage) between the value z(C), with C the catalogue generated by one method or the other, and a Lagrangian bound on z(C) is calculated. The lower the GAP, the more efficient the method.

The difference between the z(C) value and a Lagrangian bound on z(C) obtained are as follows:

Easy Instance: Dynamic: 1.18%; Random: 5.70%

Medium Instance: Dynamic: 10.30%; Random: 47.85%

Difficult Instance: Dynamic: 13.54%; Random: 48.44%

These results clearly show effectiveness of the dynamic method described above compared with the random method known in the state of the art.

1. A palletisation process, comprising:
transporting articles of heterogeneous shapes to a loading station by conveying means,
loading the articles in several layers by a loading device onto a container arranged in the loading station,
wherein, the loading device being controlled by computer control means, the process further comprises a step of generating a stable arrangement of said articles on the container upstream of their loading,
wherein said stable arrangement comprises placing articles having substantially similar heights to form either complete layers occupying substantially the entire surface area of the container, or partial layers each occupying a part of the surface area of the container,
and wherein a first partial layer having a first layer height occupies a part of the container and at least one complementary partial layer having a second layer height occupies a second part not occupied by said first layer so as to occupy the entire surface area of the container.

2. The palletisation process according to claim 1, wherein two partial layers of substantially the same surface area are superimposed.

3. The palletisation process according to claim 2, wherein said two partial layers are separated by a partial spacer plate having substantially the same surface area as said partial layers.

4. The palletisation process according to claim 1, wherein a partial layer and at least one complementary partial layer are laid on a complete layer.

5. The palletisation process according to claim 1, wherein a complete spacer plate separates the complete layer from the partial layers, said complete spacer plate having substantially the same surface area as the container.

6. The palletisation process according to claim 1, further comprising a step of generating a catalogue of layers likely to be placed on the container, said catalogue comprising at least one partial layer.

7. The palletisation process according to the claim 6, wherein the catalogue is progressively enriched by the addition of possible new layers having a strictly negative cost, said cost being deduced from the solution of the following linear problem:
$$\begin{matrix}z ( C ) = max & {\sum }_{c ∈ C} {p}_{c} {λ}_{c} & \\ s . c . & {\sum }_{c ∈ C} {q}_{i}^{c} {λ}_{c} \leq {n}_{i} & ∀ i ∈ I \\ & {λ}_{c} \geq 0 & ∀ c ∈ C\end{matrix}$$
where:
z(C): is a value corresponding to the highest layer profit that can be obtained using a real number of layers in the catalogue ϵ.
p_{c}: is the profit of layer c, evaluated as the volume of objects in layer c, plus a penalty proportional to the volume occupied by layer c in the container.
λ_{c}: the number of times layer c is used.
qᵢ^{c}: the number of articles i in layer c.
I: is a set of article references i known to the system.
ni: the number of times reference i can be used.
said cost CR(c) being expressed by the formula:
$$CR ( c ) = {p}_{c} - {\sum }_{i ∈ I} {u}_{i} {q}_{i}^{c}$$
Where uᵢ the dual value of the proviso:
$${\sum }_{c ∈ C} {q}_{i}^{c} {λ}_{c} \leq {n}_{i} \qquad ∀ i ∈ I$$
The profit p_{c} of a layer being expressed by the following formula:
$${p}_{c} = {\sum }_{i ∈ I} {v}_{i} {q}_{i}^{c} - α {v}_{c}$$
Where v_{c} is the volume of the layer, vᵢ the volume of an article i and α a real number.

8. The palletisation process according to claim 7, wherein complete or partial layers are selected from the catalogue, which maximise the sum of the profits under the proviso that the set of layers selected can be arranged on the container and without exceeding a limit height of the container, set upstream.

9. The palletisation system comprising:
a loading station comprising a zone for receiving a container and a loading device,
conveying means for transporting articles of heterogeneous shapes to the loading station to be loaded in several layers onto the container by the loading device,
wherein the loading device being controlled by computer control means configured to generate a stable arrangement of said articles on the container by implementing the process according to claim 1.
